(19) United States
(12) Patent Application Publication
(10) Pub. No.: US 2005/0066135 A1
(43) Pub. Date: Mar. 24, 2005

(54) Memory control apparatus and memory control method

(75) Inventor: Tadashi Yoshida, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Tokyo (JP)

(21) Appl. No.: 10/940,607

(22) Filed: Sep. 15, 2004

(30) Foreign Application Priority Data
Sep. 18, 2003 (JP) 2003-326625

(51) Int. Cl. G06F 12/00

(52) U.S. Cl. 711/151

(57) ABSTRACT

FIFO buffers are mounted on respective ports of a memory control apparatus having a plurality of ports and in which tag information is generated and stored in buffers 21 to 24 together with an address in accordance with the priority when a memory is accessed and the access order to the respective ports is guaranteed in the hardware by reconstructing the priority based on tag information at the exit portion of the buffer. In a memory control apparatus having ports with a plurality of buffers mounted thereon, there are provided a memory control apparatus for guaranteeing the access order to the memory and a memory control method for controlling such memory control apparatus.

### BACKGROUND OF THE INVENTION

1. Field of the Invention

The present invention relates to a memory control apparatus and a memory control method thereof.

2. Description of the Related Art

In the LSI (large scale integrated circuit) available in recent years, a CPU (central processing unit), a memory, a peripheral circuit such as an I/O (input-output) and a hardware engine are mounted on the chip, thereby realizing a desired system by one chip. This large scale integrated circuit (LSI) will be referred to as a “system on-chip”. The system on-chip will hereinafter be simply referred to as a “Soc”.

FIG. 1 of the accompanying drawings is a schematic block diagram showing an arrangement of a part of the Soc (system on-chip) according to the related art. As shown in FIG. 1, in this SoC, various kinds of hardware engines such as a CPU and a DMA (direct memory access) are connected through system buses 55 to 58 to ports 71 to 74 of a memory control apparatus 61 as bus masters 51 to 54 to access a shared memory 6. A plurality of system buses 55 to 58 are connected to the bus masters 51 to 54 in order to improve performance of the whole of the system. The system masters 51 to 54 are able to access the shared memory 6 at an arbitrary timing. In the memory having the shared memory 6, it is necessary to guarantee coherency by controlling the access order according to some method.

FIG. 2 is a schematic block diagram showing an arrangement of an example of a memory control apparatus according to the related art. As shown in FIG. 2, in order for the side of a memory control apparatus 61 to guarantee the access order from a plurality of ports, the memory control apparatus 61 incorporates therein a single buffer 62, an arbitration circuit 64 to which port interfaces (port IF) 66 to 69 of the respective ports are connected is adapted to generate the priority in accordance with the access order from the respective ports and address packets and data packets are stored in the buffer 62 in accordance with the priority, whereby the access order is guaranteed in the hardware. According the related-art arrangement, with respect to the access from the low-order port, the system bus is placed in the wait mode until the access from the higher-order port is processed so that performance demonstrated when other bus master on the same system bus accesses a bus slave except the memory is caused to be degraded.

FIG. 3 is a schematic block diagram showing an arrangement of another example of a related-art memory control apparatus in which the above-described defect can be removed. In FIG. 3, elements and parts identical to those of FIG. 2 are denoted by the identical reference numerals.

In order to remove the above-described defect, as shown in FIG. 3, the respective port interfaces 66 to 69 of the memory control apparatus 61 have buffers 621 to 624 connected thereto, respectively. The buffers 621 to 624 are made of FIFO (fast-in fast-out) memories which are adapted to output data in the sequential order of data inputted thereto. The fast-in fast-out memories will hereinafter be simply referred to as “FIFO buffers”. In this case, in accordance with the order of the arrival of the access requests to the memory control apparatus 61, the access requests from the respective port interfaces 66 to 69 are queued and managed. For example, the access request reached the port interface 66 is queued in the arbitration circuit 63 through a control path shown by the reference letter P in FIG. 3, in accordance with the order of the arrival of the access request. On the other hand, an address packet and a data packet comprising the transaction are queued from the port interface 66 to the buffer 621 through a path shown by the reference letter Q in FIG. 3. The arbitration circuit 63 evaluates the arrival order of the access requests in accordance with the queued access requests. Then, the arbitration unit 64′ connected to the exit of the buffer is adapted to obtain the packets from the respective buffers 621 to 624 through a path shown by the reference letter R in FIG. 3 based on the thus evaluated arrival order of the access requests and transmits the thus obtained packets to a memory bus cycle control unit 65.

The cited patent reference 1 has proposed a computer system that can improve throughput and which can be operated at higher speed by providing an FIFO buffer.

[Cited Patent Reference 1]:

Official gazette of Japanese laid-open patent application No. 2003-196033

In the above-described memory control apparatus according to the related art, since the arrival order of the access requests to the memory control apparatus is evaluated by the arbitration circuit provided at the exit of the buffer through the control path of the different system from that of the address packet and the data packet comprising the transaction, when a control logic falls into a minor loop, the control logic will become difficult to return to the original state later on.

Also, in the computer system that has been disclosed in the cited patent reference 1, the FIFO buffer is applied to a media drive apparatus such as a flexible disc control apparatus but the application of the FIFO buffer to the memory control apparatus is not disclosed in the cited patent reference 1.

On the other hand, in order to decrease power consumption of the SoC, since it is effective that each system bus should be operated at the minimum frequency corresponding to a transfer traffic, it is inevitable that each port of the memory control apparatus has to process the access request at different frequencies. Further, since each port has a write buffer mounted thereon to improve transfer efficiency of the system bus, it is necessary to switch clock frequencies efficiently while performance at which the memory control apparatus is accessed in writing is being improved.

In other words, although the memory control apparatus including a plurality of ports has the buffers mounted to the respective ports in order to improve performance and to decrease power consumption, it is necessary to guarantee the access order to the memory control apparatus.

### SUMMARY OF THE INVENTION

In view of the aforesaid aspect, it is an object of the present invention to provide a memory control apparatus having a plurality of ports with buffers in which the access order to the memory can be guaranteed.

It is another object of the present invention to provide a memory control method for controlling the above-mentioned memory control apparatus.

According to an aspect of the present invention, there is provided a memory control apparatus which is comprised of a plurality of port interfaces connected to a plurality of ports to process input and output data, a buffer for queuing an access request inputted and outputted through a plurality of port interfaces, an access order management block unit for managing the order of an access request inputted and outputted through a plurality of port interfaces and generating tag information in accordance with the order of the access request, an arbitration circuit for reconstructing the order of the access request based on the tag information and a memory bus cycle control unit for reading and/or writing data from and/or in a memory in accordance with the order determined by the arbitration circuit.

According to another aspect of the present invention, there is provided a memory control method which is comprised of the steps of a step for sampling a plurality of ports with different operation frequencies by the highest speed clock of the operation frequencies, a step for generating tag information in accordance with the order of arrival of an access request detected by the sampling and a step for queuing the tag information on a tag information FIFO buffer provided at every port, wherein the access order to the port is guaranteed by reconstructing the order of processing based on tag information registered on the tag information FIFO buffer.

According to the present invention, the access order to the respective ports can be guaranteed by the hardware. Also, since tag information is transmitted to the data path together with address, the FIFO buffers can be mounted on the respective ports of the memory control apparatus by simple control operation, and it is possible to realize a circuit arrangement which is excellent in endurance against noises.

Further, according to the present invention, since the FIFO buffer is mounted on every port, it becomes possible to guarantee the access order relative to the memory access requests from a plurality of ports with different operation frequencies.

Furthermore, since the tag information corresponding to the arrival order is generated and stored in the FIFO buffer together with the address when the memory is accessed by each port, it is possible to realize a memory control apparatus with high quality which is difficult to be affected by a noise and the like when the priority order is reconstructed at the exit portion of the buffer.

### BRIEF DESCRIPTION OF THE DRAWINGS

FIG. 1 is a schematic block diagram showing an arrangement of a part of an SoC (system on-chip) according to the related art;

FIG. 2 is a schematic block diagram showing an example of an arrangement of a memory control apparatus according to the related art;

FIG. 3 is a schematic block diagram another example of an arrangement of a memory control apparatus according to the related art;

FIG. 4 is a block diagram showing an example of an arrangement of a memory control apparatus according to an embodiment of the present invention;

FIG. 5 is a diagram to which reference will be made in explaining an example of pipeline processing executed by a pipeline bus; and

FIG. 6 is a diagram to which reference will be made in explaining an example of the manner in which tag information is generated according to an embodiment of the present invention.

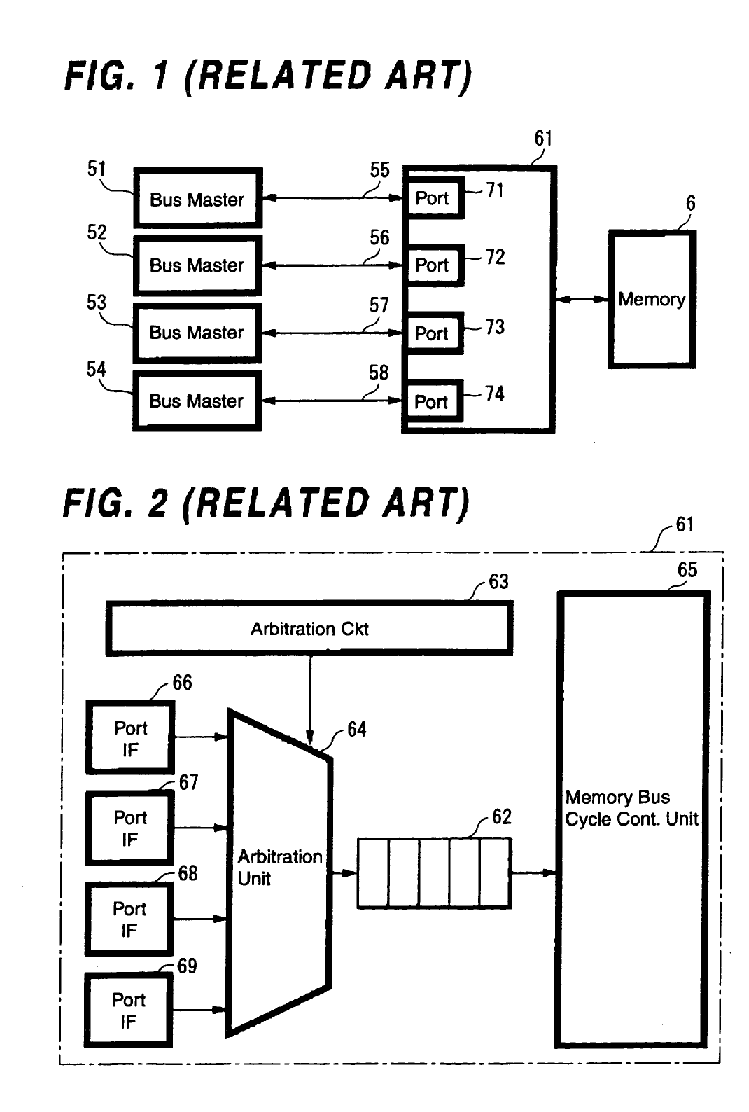

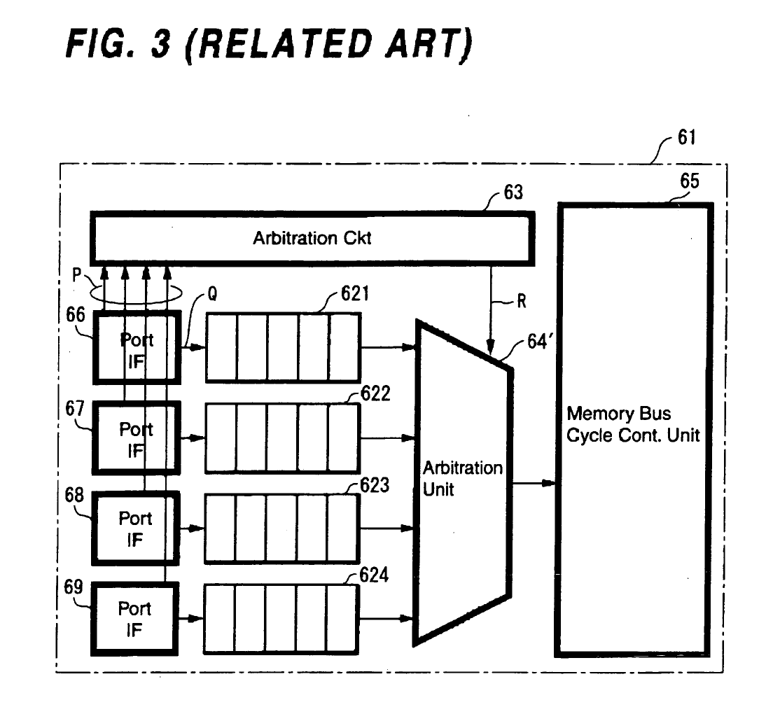

### DESCRIPTION OF THE PREFERRED EMBODIMENTS

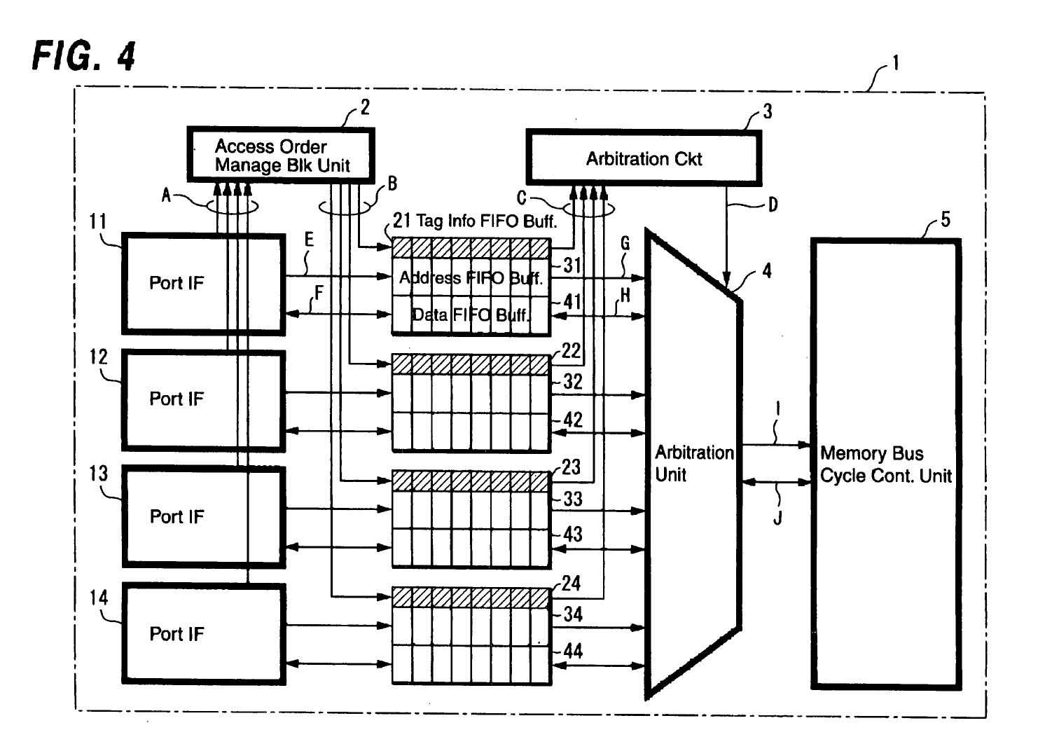

A memory control apparatus and a memory control method according to the embodiment of the present invention will hereinafter be described with reference to FIGS. 4 to 6.

FIG. 4 is a block diagram showing an arrangement of an example of a memory control apparatus according to the embodiment of the present invention. A memory control apparatus, generally denoted by the reference numeral 1 in FIG. 4, includes a plurality of ports, although not shown, and those ports are connected to system buses, respectively. Access requests generated from the bus masters on the system buses are supplied through the system buses and the ports of the memory control apparatus 1 to port interfaces 11 to 14 provided at every port.

The respective ports include address FIFO buffers 31 to 34 to queue address packets and data FIFO buffers 41 to 44 to queue data packets. Also, the memory control apparatus 1 includes an access order management block unit 2 to manage the sequential order of the access requests reached the respective ports. Tag information FIFO buffers 21 to 24 are mounted on the respective ports to queue tag information generated from the access order management block unit 2. An arbitration circuit 3 is adapted to process the access requests from the respective ports in accordance with the access order. In accordance with the processing order reconstructed by the arbitration circuit 3, an arbitration unit 4 reads information from the address FIFO buffers 31 to 34 and the data FIFO buffers 41 to 44 and supplies the thus read out information to a memory bus cycle control unit 5. The memory control apparatus 1 is constructed as described above.

Operations of the memory control apparatus 1 having the above-mentioned arrangement will be described next.

First, a clock switching means for enabling the side of the memory control apparatus 1 to process the access requests from the respective ports, which are operated at different frequencies, with its frequency will be described. Each system bus is operated at an operation frequency corresponding to the transfer traffic in order to decrease power consumption and hence a difference between the frequencies of the respective ports and the memory control apparatus 1 should be canceled out. To this end, the respective port interfaces 11 to 12 are connected to the address FIFO buffers 31 to 34 and the data FIFO buffers 41 to 44 to receive the access request packets and to write the same in the data FIFO buffers 41 to 44. On the other hand, in the arbitration circuit 3 and the arbitration unit 4, the processing order is reconstructed in accordance with the operation frequency of the side of the memory control apparatus 1 and information is read out from the address FIFO buffers 31 to 34 and the data FIFO buffers 41 to 44. In this manner, the address FIFO buffers 31 to 34 and the data FIFO buffers 41 to 44 are provided and information is received and transmitted through the address FIFO buffers 31 to 34 and the data FIFO buffers 41 to 44, whereby the difference between the write speed and the read speed can be canceled out and the clock frequency can be switched.

Next, the means for holding the access order from the respective ports when information is received and transmitted through the address FIFO buffers 31 to 34 and the data FIFO buffers 41 to 44 will be described. As described above, when the access requests from the respective ports are written in the address FIFO buffers 31 to 34 and the data FIFO buffers 41 to 44, information concerning the access order is lost at that time. Therefore, according to this embodiment, there is provided an access order management block unit 2 in which the respective ports of the memory control apparatus 1 are sampled by the highest speed clock of the system bus through the path shown by the reference letter A in FIG. 4 and it is monitored whether the bus masters on the respective system buses transmit address packets to the memory control apparatus 1. This access order management block 2 generates tag information corresponding to the priority to the respective address packets based on the monitored results. Then, when the contents of the address packets of the access requests received at the respective port interfaces 11 to 14 from the bus masters are stored in the address FIFO buffers 31 to 34, the addresses are added to the tag information and written in the tag information FIFO buffers 21 to 24 provided at every port through the path shown by the reference letter B in FIG. 4. As described above, the tag information is generated by the access order management block unit 2 and stored in the address FIFO buffers 31 to 34, thereby making it possible to hold the information concerning the access order.

Next, the means for processing the access requests from the respective ports in accordance with the access order in the arbitration circuit 3 will be described. By means of the path shown by the reference letter C in FIG. 4, the arbitration circuit 3 evaluates the access order with reference to the information at the exit portions of the tag information FIFO buffers 21 to 24 of the respective ports and reconstructs the processing order in accordance with the access order. The arbitration circuit 3 transmits information to the arbitration unit 4 through a path shown by the reference letter D in FIG. 4 such that information is obtained from the FIFO buffer of the port having the highest priority in accordance with the thus reconstructed processing order. The arbitration unit 4 reads the address packet from the address FIFO buffer of the port to which the above information is transmitted. Further, the arbitration unit 4 reads the data packet corresponding to the above-mentioned address packet from the data FIFO buffer and transmits the thus read out information to the memory bus cycle control unit 5.

The memory control apparatus according to the present invention is constructed as described above and hence the access order among a plurality of ports of the memory control apparatus can be guaranteed by the hardware.

The case in which the memory control apparatus according to this embodiment is applied to a pipeline bus will be described next. As the system bus of the SoC is becoming higher in speed progressively in recent years, a pipeline bus for transferring address packets and data packets in a time-division manner is becoming the main current in order to increase the operation frequency. An example of pipeline processing executed by this pipeline bus will be described with reference to FIG. 5.

As shown in FIG. 5, when some data is transferred, an address packet (Addr3) All is transmitted at an N-th cycle and a data packet (Data3) D11 is transmitted and received at a (N+1)-th cycle. At the time of the N-th cycle, a data packet (Data2) D12 of the address packet (Addr2) A12 that has been transmitted at a (N−1)-th cycle is transferred. In this manner, according to the pipeline control, the processors of the respective stages are operated independently, whereby the processing of the next packet can be executed before the processing of the preceding packet is ended. When burst output data is transferred, a flag (Burst4) F11 of the leading address packet is transmitted to the system bus, and then data (Addr1 to Addr4) of a plurality of address packets are transmitted successively.

When the memory control apparatus according to this embodiment is applied to the pipeline bus, the port interfaces 11 to 14 of the respective ports of the memory control apparatus 1 shown in FIG. 4 are mounted on the memory control apparatus 1 as the interfaces of the above-described pipeline buses.

The control means required when the access requests are transmitted from the bus masters of a plurality of pipeline buses to the memory control apparatus according to this embodiment will be described next. A bit width w of tag information generated from the access order management block 2 depends upon the number of the ports and the storage capacity of the address FIFO buffer. When n assumes the number of the ports and m assumes the memory capacity of the address FIFO buffer, then the bit width w of the tag information is expressed by the following equation (1):
w=log₂ (n×m) (1)

For example, when the number of the ports is 4 and the memory capacity of the address FIFO buffer is 8, then the bit width of the tag information becomes 5 bits, and hence tag information is counted from 5′b00000 to 5″b11111 in accordance with the order of the arrival of the access requests. The arbitration circuit 3 gives the processing permission to the access request having tag information in which “l is added to the tag information that is now being accessed and it transmits the packet information of that access request to the memory bus cycle control unit 5.

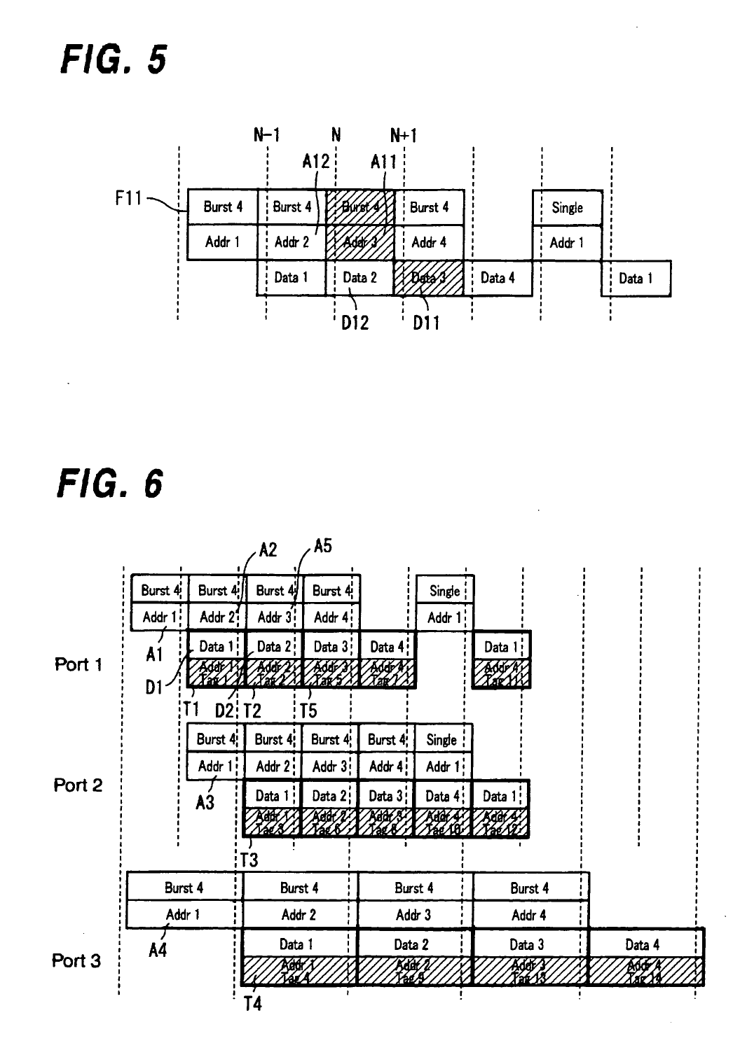

FIG. 6 shows an example in which the access order management block unit 2 generates tag information when the access requests are generated from the three ports. For example, let us describe the case in which the access requests reached the ports 1 to 3 are placed in the states shown in FIG. 6. In this case, let it be assumed that the operation frequencies of the ports 1 to 3 are different, for example, let it be assumed that the ports 1 and 2 are operated at substantially the same operation frequency and that the port 3 is operated at the frequency higher than those of the ports 1 and 2. At that time, the sequential order of the packets reached the memory control apparatus 1 is assumed to be “Addr1 of port 1” A1, “Addr2 of port 1” A2, “Addr1 of port 2” A3, “Addr1 of port 3” A4 and “Addr3 of port 1” A5, in that order. Since the access order management block unit 2 generates the tag information in accordance with the above-described order of the arrival of the access requests, the access order management block unit 2 generates “Tag1” relative to “Addr1 of port 1” A1, adds address information (Addr1) to “Tag1” and queues the resultant information in the tag information FIFO buffer (T1). The access order management block unit 2 generates “Tag2” in which “1” is added to “Tag1” relative to “Addr2 of port 1” A2, adds address information (Addr2) to “Tag2” and queues the resultant information in the tag information FIFO buffer (T2). In a like manner, the access order management block unit 2 generates tag information while counting the access request in the ascending order in such a way as to generate “Tag3” in which “1” is added to “tag2” relative to “Addr1 of port 2” A3. Then, the access order management block unit 2 adds the address information to the thus generated tag information and queues the resultant information on the tag information FIFO buffers 21 to 24.

On the other hand, the arbitration circuit 3 gives the processing permission to the access request of “Addr1 of port 1”A1 to which “Tag1” is added with reference to information of the tag information FIFO buffers 21 to 24, and the arbitration unit 4 obtains “Data1 of port 1” D1 from the data FIFO buffer and transmits the thus obtained data to the memory bus cycle control unit 5. Next, the arbitration circuit 3 gives the processing permission to the access request of “Addr2 of port 1” D2 with “Tag 2” in which 1 was added to “Tag1” added thereto. Then, the arbitration unit 4 obtains “Data2 of port 1” D2 from the data FIFO buffer and transmits the thus obtained information to the memory bus cycle control unit 5. In this manner, the arbitration circuit 3 reconstructs the processing order based upon the tag information generated by the access order management block unit 2, whereby the access order among a plurality of ports can be guaranteed by the hardware.

After the tag information generated by the access order management block unit 2 has been counted up to 5′b11111, the counting of tag information is again returned to 5′b00000 and tag information is started to be counted. When tag information is evaluated by the arbitration circuit 3, tag information of the new cycle is evaluated after processing of all tag information of the preceding cycles was ended.

Also, the above-described data FIFO buffers 41 to 44 can be used both for writing data in the memory and for reading out data from the memory. In the case of the request for writing data from the bus master on the system bus in the memory, first, address data of write data transmitted from the bus master are supplied from the port interfaces 11 to 14 to the address FIFO buffers 31 to 34 through the path shown by the reference letter E in FIG. 4. Then, the contents of the data are queued in the data FIFO buffers 41 to 44 from the port interfaces 11 to 14 through the path shown by the reference letter F in FIG. 4. Next, the arbitration unit 4 reads out the address data from the address FIFO buffers 31 to 34 through the path shown by the reference letter G in FIG. 4, and it reads out data from the data FIFO buffers 41 to 44 through the path shown by the reference letter H in FIG. 4. Next, the arbitration unit 4 transmits the thus read-out address data and data to the memory bus cycle control unit 5 through the paths shown by the reference letters I and J in FIG. 4 and thereby the data are written in the corresponding addresses of the memory. On the other hand, in the case of the access request for reading out the data from the memory, read target address data transmitted from the bus masters are queued from the port interfaces 11 to 14 to the address FIFO buffers 31 to 34 through the path shown by the reference letter E in FIG. 4. The arbitration unit 4 reads out the read target address data from the address FIFO buffers 31 to 34 and transmits the thus read out address data to the memory bus cycle control unit 5 through the path shown by the reference letter I in FIG. 4. The memory bus cycle control unit 5 reads out the corresponding address data from the memory and transmits the thus read out address data to the arbitration unit 4 through the path shown by the reference letter J in FIG. 4. The arbitration unit 4 queues the contents of the thus read out address data in the data FIFO buffers 41 to 44 through the path shown by the reference letter H in FIG. 4. After that, that data is transmitted to the port interfaces 11 to 14 through the path shown by the reference letter Fin FIG. 4 and transmitted to the request source bus master from the port interfaces 11 to 14 through the system bus. When the data FIFO buffers 41 to 44 are used both for writing and reading data in and from the memory as described above, a cost of the memory control apparatus can be suppressed from being increased, and efficiency at which the system bus is used when the memory is accessed can be improved.

As described above, according to the present invention, there is provided a memory control apparatus which is comprised of a plurality of port interfaces connected to a plurality of ports to process input and output data, a buffer for queuing an access request inputted and outputted through a plurality of port interfaces, an access order management block unit for managing the order of an access request inputted and outputted through a plurality of port interfaces and generating tag information in accordance with the order of the access request, an arbitration circuit for reconstructing the order of the access request based on the tag information and a memory bus cycle control unit for reading and/or writing data from and/or in a memory in accordance with the order determined by the arbitration circuit.

Further, according to the present invention, there is provided a memory control method which is comprised of the steps of a step for sampling a plurality of ports with different operation frequencies by the highest speed clock of the operation frequencies, a step for generating tag information in accordance with the order of arrival of an access request detected by the sampling and a step for queuing the tag information on a tag information FIFO buffer provided at every port, wherein the access order to the port is guaranteed by reconstructing the order of processing based on tag information registered on the tag information FIFO buffer.

According to the present invention, the access order to the respective ports can be guaranteed by the hardware. Also, since the tag information is transmitted to the data path together with address, the FIFO buffers can be mounted on the respective ports of the memory control apparatus by simple control operation, and it is possible to realize a circuit arrangement which is excellent in endurance against noises.

Further, according to the present invention, since the FIFO buffer is mounted on every port, it becomes possible to guarantee the access order relative to the memory access requests from a plurality of ports with different operation frequencies.

Furthermore, since the tag information corresponding to the arrival order is generated and stored in the FIFO buffer together with the address when the memory is accessed by each port, it is possible to realize a memory control apparatus with high quality which is difficult to be affected by a noise and the like when the priority order is reconstructed at the exit of the buffer.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

1. A memory control apparatus comprising:
a plurality of port interfaces connected to a plurality of ports to process input and output data;
a buffer for queuing an access request inputted and outputted through said plurality of port interfaces;
an access order management block unit for managing the order of an access request inputted and outputted through said plurality of port interfaces and generating tag information in accordance with the order of said access request;
an arbitration circuit for reconstructing the order of said access request based on said tag information; and
a memory bus cycle control unit for reading and/or writing data from and/or in a memory in accordance with the order determined by said arbitration circuit.

2. A memory control apparatus according to claim 1, wherein said buffer is composed of a tag information FIFO buffer for queuing tag information generated from said access order management block unit, a memory access address FIFO buffer and a data FIFO buffer.

3. A memory control method comprising the steps of:
a step for sampling a plurality of ports with different operation frequencies by the highest speed clock of said operation frequencies;
a step for generating tag information in accordance with the order of arrival of an access request detected by said sampling; and
a step for queuing said tag information on a tag information FIFO buffer provided at every port, wherein the access order to said port is guaranteed by reconstructing the order of processing based on tag information queued on said tag information FIFO buffer.

4. A memory control method according to claim 3, wherein a bit width of a tag of said tag information depends on the number of said ports and the memory capacity of said address FIFO buffer and a tag is generated by adding said tag information one by one in accordance with the order in which an access request arrives at said port.

5. A memory control method according to claim 3, wherein address contained in said access request arrived at said port is added to said tag information and queued on said tag information FIFO buffer when said tag information is queued on said tag information FIFO buffer.
